(19) United States
(12) Patent Application Publication
(10) Pub. No.: US 2006/0059696 A1
(43) Pub. Date: Mar. 23, 2006

(54) Controller for hand-held electrical device for cutting hair

(75) Inventors: Robert E. Derby, Racine, WI (US); Matthew L Andis, Racine, WI (US)

Correspondence Address: MICHAEL BEST & FRIEDRICH, LLP, 100 E WISCONSIN AVENUE, MILWAUKEE, WI, 53202, US

(73) Assignee: Andis Company, Sturdevant, WI (US)

(21) Appl. No.: 10/943,674

(22) Filed: Sep. 17, 2004

(51) Int. Cl. B26B 19/02

(52) U.S. Cl. 30/210

(57) ABSTRACT

A hair clipper or trimmer including a controller and a pivot motor operable to control a reciprocating blade at a speed greater than 3,600 blade strokes per minute.

### BACKGROUND OF THE INVENTION

Hand-held electrical devices, such as hair trimmers and clippers, typically include a motor. Hair trimmers and clippers can include a magnetic motor or a pivot motor. A magnetic motor generally operates (in the United States) with alternating current at 60 Hz (e.g., 60 cycles per second), and causes a blade to move 120 blade strokes per second. The magnetic motor generally provides 7,200 blade strokes per minute.

A pivot motor generally operates (in the United States) with alternating current at 60 Hz, and causes a blade to move 60 blade strokes per second. The pivot motor generally provides 3,600 blade strokes per minute.

### SUMMARY

It would be desirable to have a hair clipper including a pivot motor that can operate at the same speed as a hair clipper including a magnetic motor.

In one embodiment, the invention includes a hair clipper comprising a cutting blade, a pivot motor coupled to the cutting blade, and a controller operable to controllably provide electric power to the pivot motor to move the cutting blade at a speed greater than 3,600 blade strokes per minute.

In another embodiment, the invention includes a controller for a pivot motor in a hair clipper. The controller comprises a power supply circuit operable to convert an alternating current (AC) signal to a direct current (DC) signal, a drive circuit operable to receive the DC signal and to generate a plurality of DC pulses, and a bridge circuit coupled to the pivot motor, the bridge circuit operable to switch the DC pulses, transform the DC pulses to a variable frequency AC signal, and transmit the variable frequency AC signal to the pivot motor.

In yet another embodiment, the invention includes a hand-held electrical device comprising a housing, a blade set coupled to the housing, the blade set including a stationary blade and a reciprocating blade, an actuator supported by the housing, the actuator driveably connected to the blade set, and a controller supported by the housing, the controller operable to convert an alternating current (AC) signal to a direct current (DC) signal, generate a plurality of DC pulses, and transform the DC pulses to a variable frequency AC signal that is transmitted to the actuator to move the reciprocating blade.

### BRIEF DESCRIPTION OF THE DRAWINGS

FIG. 1 illustrates a top view of a hair clipper or trimmer.

FIG. 2 illustrates a top view of the hair clipper or trimmer of FIG. 1 with a portion of a housing removed.

FIG. 3 illustrates a top view of a pivot motor of the hair clipper or trimmer of FIG. 1, the pivot motor being in a first position.

FIG. 4 illustrates a top view of a pivot motor of the hair clipper or trimmer of FIG. 1, the pivot motor being in a second position.

FIG. 5 illustrates a top view of a pivot motor of the hair clipper or trimmer of FIG. 1, the pivot motor being in a third position.

FIG. 6 illustrates a schematic diagram of a controller of the hair clipper or trimmer of FIG. 1.

FIG. 7 illustrates a first construction of a schematic diagram of a power supply circuit of the controller of FIG. 6.

FIG. 8 illustrates a second construction of a schematic diagram of a power supply circuit of the controller of FIG. 6.

FIG. 9 illustrates a third construction of a schematic diagram of a power supply circuit of the controller of FIG. 6.

FIG. 10 illustrates a first construction of a schematic diagram of a drive circuit of the controller of FIG. 6.

FIG. 11 illustrates a second construction of a schematic diagram of a drive circuit of the controller of FIG. 6.

FIG. 12 illustrates a third construction of a schematic diagram of a drive circuit of the controller of FIG. 6.

FIG. 13 illustrates a first construction of a schematic diagram of an bridge circuit of the controller of FIG. 6.

FIG. 14 illustrates a second construction of a schematic diagram of an bridge circuit of the controller of FIG. 6.

FIG. 15 illustrates a second arrangement of the hair clipper or trimmer of FIG. 1 with the controller of FIG. 6.

FIG. 16 illustrates a third arrangement of the hair clipper or trimmer of FIG. 1 with the controller of FIG. 6.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising,” or “having” and variations thereof herein is meant to encompass the items listed thereafter and equivalents thereof as well as additional items. The terms “mounted,” “connected,” “supported,“and “coupled” are used broadly and encompass both direct and indirect mounting, connecting, supporting, and coupling. Further, “connected,” “supported,” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

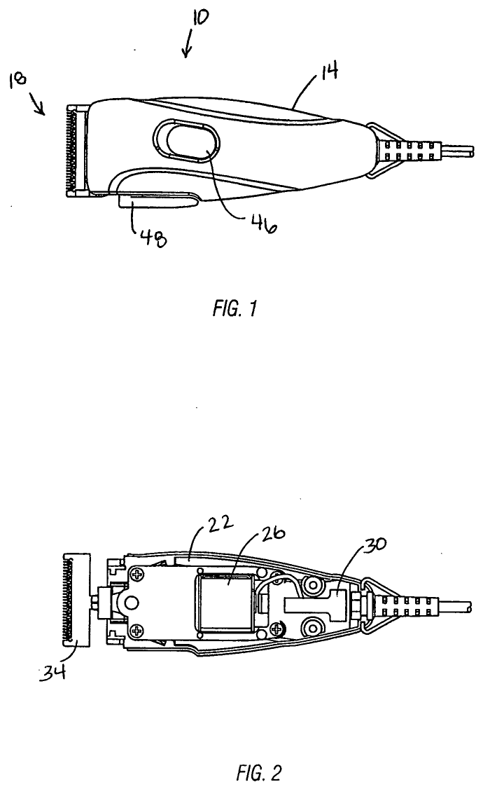

FIG. 1 illustrates a hair trimmer or clipper 10 according to one embodiment of the present invention. The hair clipper 10 includes a hollow, elongated housing 14 having a cutting end 18. The illustrated housing 14 can be constructed of an electrically insulating material, such as plastic, and can include a plurality of sections or parts which are connected together to define an inner cavity 22 (see FIG. 2). The housing 14 can be constructed with other types of material and according to other designs, such as a design that includes more or fewer sections or parts than the number of sections or parts illustrated in the drawings.

The housing 14 can support an electric motor (e.g., pivot motor or vibratory motor) or actuator 26 and a motor controller 30 electrically connected to the electric motor 26. As illustrated in FIGS. 2-5, the electric motor 26 (shown as a pivot motor) is drivingly connected to a blade set 34, which is supported by the housing 14 at the cutting end 18. The blade set 34 includes a fixed blade 38 mounted on the housing 14 and a movable or reciprocating blade 42 biased against and moveable with respect to the fixed blade 38 by the electric motor 26. The electric motor 26 is mounted in the inner cavity 22 and is drivingly connected to the blade set 38 by a drive mechanism 44.

The housing 14 can include a power switch 46 (see FIG. 1) for activation of the motor controller 30 and the electric motor 26. When the power switch 46 is activated, the motor controller 30 controllably transmits electric signals to the electric motor 26 to effect reciprocation of the movable blade 42 with respect to the fixed blade 38. The switch 46 is configured to interrupt the flow of electric power from a power supply to the motor controller 30. The electric power may include an alternating current (AC) power provided via a corded plug electrically coupled to a wall outlet and/or a direct current (DC) power provided by a battery (e.g., a rechargeable battery disposed in the cavity 22). The housing 14 can include a speed switch 48 (see FIG. 1) that can adjust the speed of the electric motor 26 and the movable blade 42.

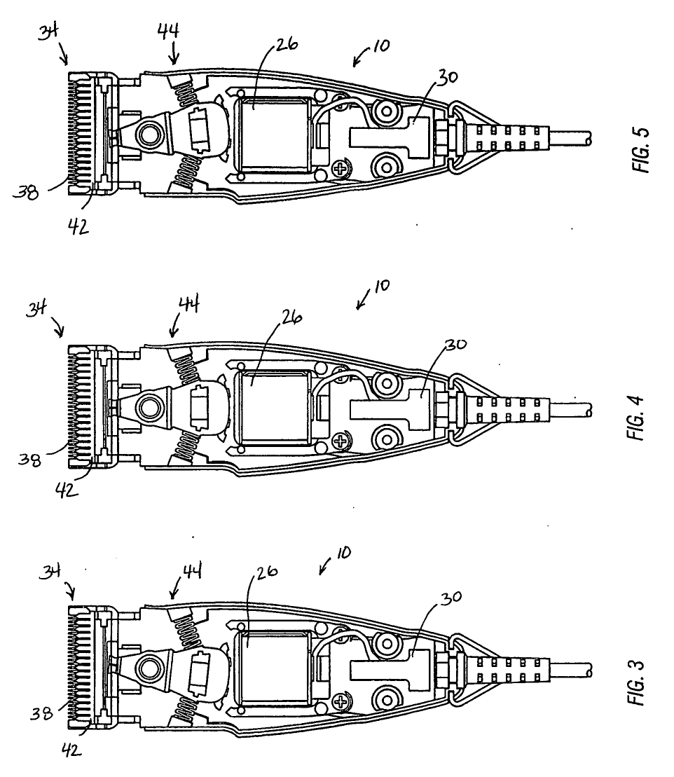

FIGS. 3-5 illustrate operation of the pivot motor 26 (also referred to as a pivot machine). FIG. 3 illustrates a power stroke in that the movable blade 42 has moved to the right when the hair clipper 10 is oriented in the vertical direction. FIG. 4 illustrates that the movable blade 42 has moved to a neutral position. FIG. 5 illustrates another power stroke in that the movable blade 42 has moved to the left when the hair clipper 10 is oriented in the vertical direction. The positions of the movable blade 42 as shown in FIGS. 3-5 illustrate one complete blade stroke of a pivot motor.

As the hair clipper 10 is guided through a person's hair, the reciprocating motion of the blade set 34 cuts the person's hair. A number of suitable blades sets, motors, and driving arrangements are known. It should be appreciated that hair trimmers having other types of blade sets, motors, and/or driving arrangements would be suitable for use in combination with the present invention.

Several of the circuit diagrams illustrated in some of the FIGs are discussed below with respect to a 120V AC input power source. It should be noted that the circuit diagrams can be adjusted and/or reconfigured to accommodate a 230/240V AC power source, such that the invention is not limited to the electric circuit diagrams illustrated in the FIGS. The description of the embodiments of the invention include various component values and/or component sources or brands that are provided as examples. It is noted that the embodiments of the invention are not limited to the specific component values provided, but rather the component values can be adjusted and/or reconfigured to accommodate any change within any of the electric circuits illustrated.

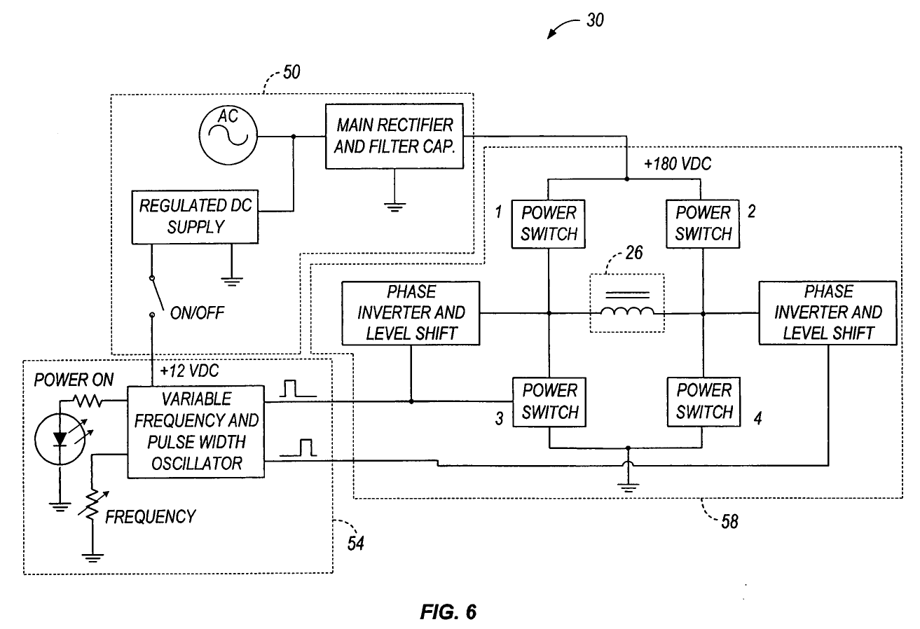

The motor controller 30 can increase the speed of the electric motor 26 in the hair clipper 10 of the present invention to operate at 7,200 blade SPM. Other speeds, greater than or less than 7,200 blade SPM, are also possible. Referring to FIG. 6, the motor controller 30 can include a power supply circuit 50, a drive circuit 54, and a bridge circuit 58. The bridge circuit 58 is operable to transmit electric signals to the electric motor 26 for operation of the movable blade 42.

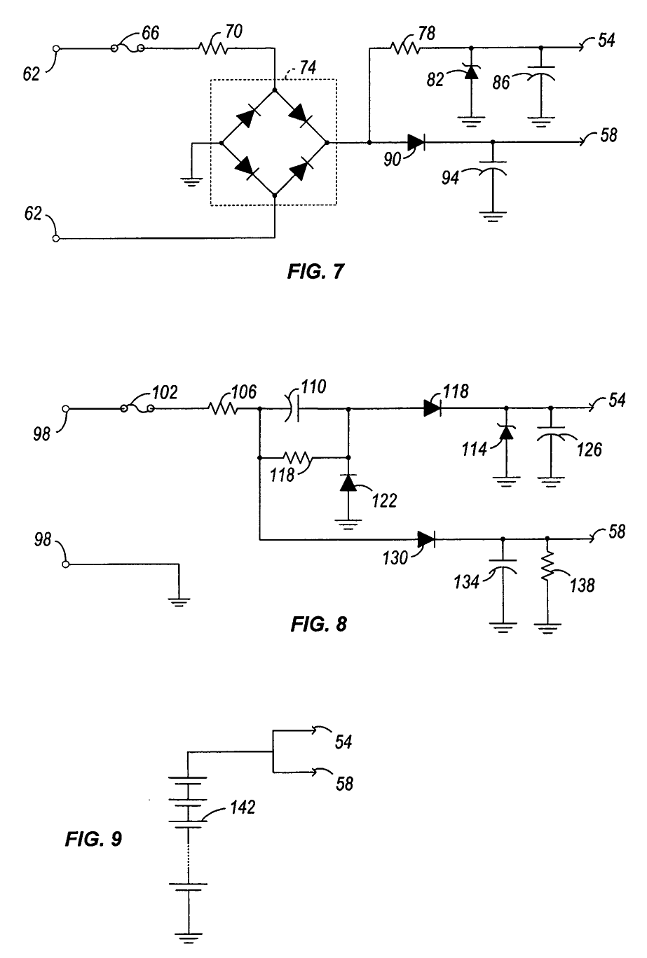

The power supply circuit 50 can provide a DC source to the drive circuit 54 and the bridge circuit 58. FIG. 7 illustrates one construction of the power supply circuit 50. For the construction shown in FIG. 7, the power supply circuit 50A includes an input terminal 62 that receives a 120V AC electric signal. The power supply circuit 50A includes a time delay fuse 66 (e.g., 0.5 A), an inrush limiting resistor 70 (e.g., 24 ohm), a diode bridge rectifier 74 (e.g., IN4007 type) operable to provide a rectified output signal (e.g., DC signal), a resistor 78 (e.g., 4.4 Kohm) operable to limit the current that is provided to a zener diode shunt regulator 82 (e.g., 15V), which provides a low voltage input to the drive circuit 54. The power supply circuit 50A also includes a filter capacitor 86 (e.g., 470 μF) operable to store the rectified signal, a blocking diode 90 (e.g., IN4007 type), and a filter capacitor 94 (e.g., 10 μF) that provides a DC input signal to the bridge circuit 58.

FIG. 8 schematically illustrates another construction of the power supply circuit 50. For the construction shown in FIG. 8, the power supply circuit 50B includes an input terminal 98 that receives a 120V AC electric signal, a time delay fuse 102 (e.g., 0.5 A), an inrush limiting resistor 106 (e.g., 24 ohm), and a capacitor 110 (e.g., 1.2 μF) operable to limit the current to a zener diode shunt regulator 114 (e.g., 15V), which provides a low voltage input to the drive circuit 54. The power supply circuit 50B also includes a discharge resistor 118 (e.g. IN4007 type) positioned in a parallel path with the capacitor 110, rectifier diodes 118 and 122 (e.g., IN4007 type) operable to provide a rectified output signal (e.g., DC signal) to the drive circuit 54, and a filter capacitor 126 (e.g., 470 μF) operable to store the rectified signal. The power supply circuit 50B further includes a rectifier diode 130 (e.g., IN4007 type), a filter capacitor 134 (e.g., 10 μF), and a discharge resistor 138 (e.g., 470 Kohm) that provides a DC input signal to the bridge circuit 58.

FIG. 9 schematically illustrates still another construction of the power supply circuit 50. For the construction shown in FIG. 9, the power supply circuit 50B includes a battery 142 operable to provide a DC input signal to the drive circuit 54 and the bridge circuit 58. The power supply circuit 50 can be modified as needed to accommodate alkaline, NiCd, or NiMH batteries as the power source for the motor 26 and the motor controller 30. The battery voltage can be in the range of about 5 volts to about 12 volts, but any voltage can be used as long as the electronics are stable and the motor power is adequate.

The drive circuit 54 illustrated in FIG. 6 can be a pulse width modulator that can provide two square wave pulse trains (A and B) to the bridge circuit 58. The two pulse trains are out of phase with each other and have an amplitude close to the supply voltage (+12 VDC or +15 VDC). Even though the pulses A and B are out of phase, they share a small period of time when no pulses occur on either A or B. This ensures that the bridge circuit 58 is not destroyed as when opposite phases are turned on at the same time. The frequency applied by the drive circuit 54 to the bridge circuit 58 can be any frequency, but is preferably in the range of about 100 Hz to about 120 Hz.

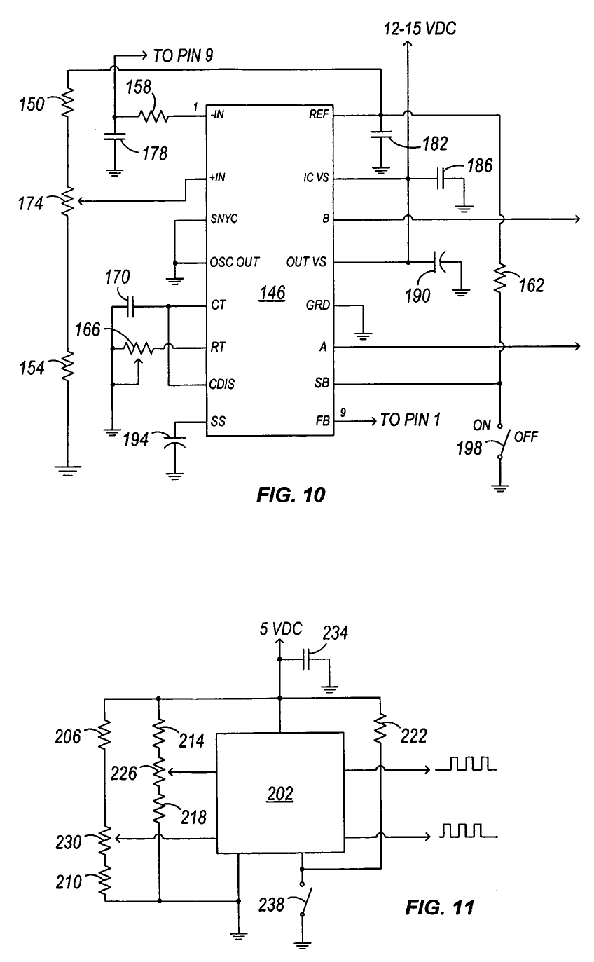

FIG. 10 schematically illustrates one construction of the drive circuit 54. For the construction shown in FIG. 10, the drive circuit 54A includes a pulse width modulator chip 146 (e.g., UC3525A type), pulse width set resistors 150 (e.g., 3 Kohm) and 154 (e.g., 1.5 Kohm), input impedance resistor 158 (e.g., 10 Kohm), and current limit resistor 162 (e.g., 5.1 Kohm). The drive circuit 54A also includes an output frequency adjustable potentiometer 166 (e.g., 250 Kohm) and an output frequency set capacitor 170 (e.g., 0.1 μF) positioned in a parallel path with the output frequency adjustable potentiometer 166. The arrangement of the output frequency adjustable potentiometer 166 and the output frequency set capacitor 170 generate an RC time constant that controls the frequency and, therefore, the speed of the electric motor 26. The output power can be adjusted by modifying the width of the output pulses using a pulse width adjustable potentiometer 174 (e.g., 10 Kohm). Output power may also be fixed. The drive circuit 54A further includes noise shunt capacitors 178 (e.g., 0.01 μF), 182 (e.g., 0.1 μF) and 186 (e.g., 0.1 μF), a current pulse capacitor 190 (e.g., 100 μF), and a “soft-start” capacitor 194 (e.g., 4.7 μF). A soft-start feature “slowly” increases the speed of the electric motor 26, thus avoiding an abrupt change on the load. The drive circuit 54A also includes a switch 198 (e.g., SPST type) (e.g., power switch 46) that provides power to the drive circuit 54A.

FIG. 11 schematically illustrates another construction of the drive circuit 54. For the construction shown in FIG. 11, the drive circuit 54B includes a microcontroller 202 programmed as a pulse width modulator that is operable to output the two pulse trains from its I/O pins. The microcontroller 202 can also be programmed to sense various analog voltages on its I/O pins to keep power constant or respond to line voltage variations. The drive circuit 54B also includes pulse width limit resistors 206 and 210, frequency limit resistors 214 and 218, current limit resistor 222 (e.g., 100 Kohm), and a frequency adjustable potentiometer 226 that controls the frequency and, therefore, the speed of the electric motor 26. The output power can be adjusted by modifying the width of the output pulses using a pulse width adjustable potentiometer 230. Output power may also be fixed. The drive circuit 54B further includes a noise shunt capacitor 234 (e.g., 0.1 μF) and a switch 238 (e.g., SPST type) (e.g., power switch 46) that provides power to the drive circuit 54B.

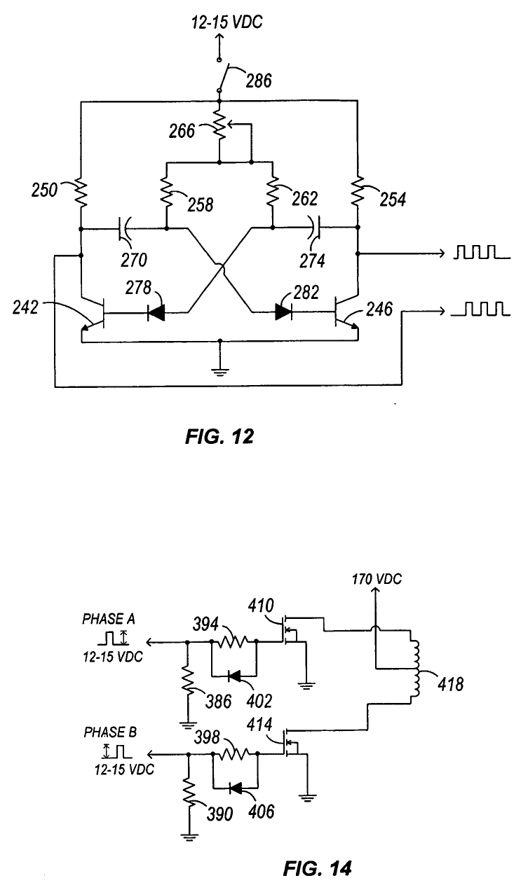

FIG. 12 schematically illustrates still another construction of the drive circuit 54. For the construction illustrated in FIG. 12, the drive circuit 54C includes oscillator transistors 242 (e.g., 2N3904 type) and 246 (e.g., 2N3904 type) that form an astable multivibrator that outputs two pulse trains as shown. It is noted that various configurations of transistors can form an astable multivibrator and that the invention is not limited to the specific configuration of the transistors illustrated. The drive circuit 54C also includes current limit resistors 250 (e.g., 15 Kohm) and 254 (e.g., 15 Kohm), frequency set resistors 258 (e.g., 150 Kohm) and 262 (e.g., 150 Kohm), and a frequency adjustable potentiometer 266 (e.g., 10 Kohm) that controls the frequency and, therefore, the speed of the electric motor 26. The drive circuit 54C further includes frequency set capacitors 270 (e.g., 0.027 μF) and 274 (e.g., 0.027 μF), steering/switching diodes 278 (e.g., IN4148 type) and 282 (e.g., IN4148 type), and a switch 286 (e.g., SPST type) (e.g., power switch 46) that provides power to the drive circuit 54C.

The drive circuit 54 and the bridge circuit 58 illustrated in FIG. 6 form an inverter. The bridge circuit 58 illustrated in FIG. 6 uses the control pulses produced by the drive circuit 54 to switch electrical energy (power) into the electric motor 26. The energy is usually rectified and filtered line voltage, but can also be low voltage (such as from batteries) for a portable hair clipper 10. The power switches are usually MOSFET transistors, but can be suitable transistors of any type, such as IGBT (insulated gate bipolar transistors) or BJT (bipolar junction transistors).

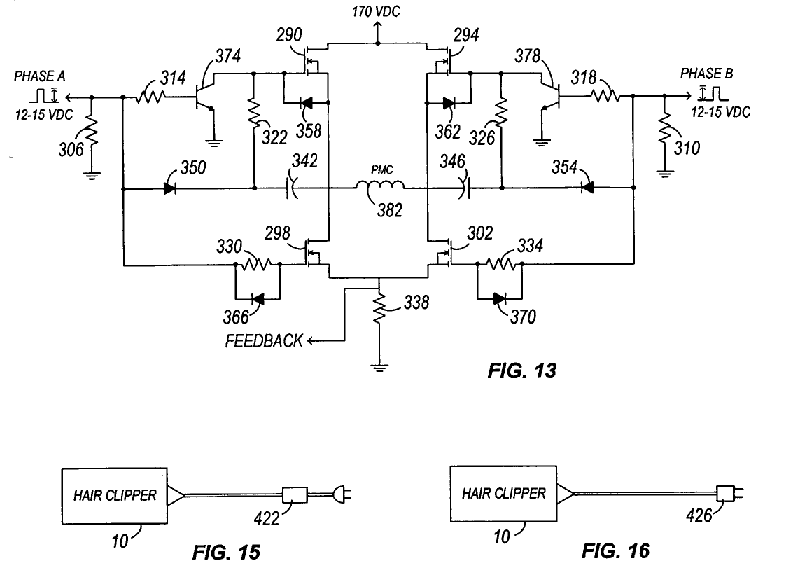

FIG. 13 schematically illustrates one construction of the bridge circuit 58. For the construction shown in FIG. 13, the bridge circuit 58A includes an “H bridge” output MOSFET transistors 290 (e.g., IRFU-220N), 294 (e.g., IRFU-220N), 298 (e.g., IRFU-220N), and 302 (e.g., IRFU-220N) operable to switch the DC pulses through the motor coil first in one direction, stop, and then switch the DC pulses in a second direction. The bridge circuit 58A also includes constant load resistors 306 (e.g., 47 Kohm) and 310 (e.g., 47 Kohm), bias resistors 314 (e.g., 68 Kohm) and 318 (e.g., 68 Kohm), gate drive resistors 322 (e.g., 22 Kohm), 326 (e.g., 22 Kohm), 330 (e.g., 100 Kohm), and 334 (e.g., 100 Kohm), a current feedback resistor 338 (e.g., 1-10 ohms), voltage pump capacitors 342 (e.g., 2.2 μF) and 346 (e.g., 2.2 μF), and voltage steering diodes 350 (e.g., IN4007 type) and 354 (e.g., IN4007 type). The bridge circuit 58A further includes gate turn-off diodes 358 (e.g., IN4148 type), 362 (e.g., IN4148 type), 366 (e.g., IN4148 type), and 370 (e.g., IN4148 type) and MOSFET turn-off transistors 374 (e.g., MPSA42 type) and 378 (e.g., MPSA42 type).

In operation, if either of the input DC pulses A or B is in a high state, the output MOSFET transistors 298 or 302 turn on through gate drive resistors 330 or 334, respectively. At the same time, the turn off transistors 374 and 378 cause the output MOSFET transistors 290 and 294 to turn off, respectively. The output MOSFET transistors 298 and 302 are discharged through gate turn off diodes 366 and 370, respectively, when either of the input DC pulses A or B is in a low state. At the same time, turn-off transistors 374 or 378 are not forward biased and the charge contained on the voltage pump capacitors 342 and 346 causes the output MOSFET transistors 290 and 294 to turn on through gate drive resistors 322 and 326, respectively. The voltage steering diodes 350 and 354 charge the voltage pump capacitors 342 and 346, respectively, with a positive voltage referenced to the voltage being applied to the motor 26. The gate turn off diodes 358 and 362 ensure a rapid turn off of the output MOSFET transistors 290 and 294, respectively. The current feedback resistor 338 allows current drawn by the motor 26 to be changed to a voltage level, which can be used for features such as overload protection or constant power.

The bridge circuit 58A illustrates the electrical location of the motor 26 and an associated motor coil 382. The motor coil 382 is single-ended, which allows for easy motor bobbin winding. A single-ended motor coil construction also allows the H-bridge output stage to use lower voltage MOSFETs with low “on-resistance.” The lower on resistance creates a cooler operation in the bridge circuit 58A.

FIG. 14 schematically illustrates another construction of the bridge circuit 58. For the construction shown in FIG. 14, the bridge circuit 58B includes constant load resistors 386 (e.g., 47 Kohm) and 390 (e.g., 47 Kohm), gate drive resistors 394 (e.g., 100 Kohm) and 398 (e.g., 100 Kohm), and gate turn-off diodes 402 (e.g., IN4148 type) and 406 (e.g., IN4148 type). The bridge circuit 58B also includes MOSFET output transistors 410 (e.g., IRFU320 type) and 414 (e.g., IRFU320 type), which turn on through the gate drive resistors 394 and 398 when either the A or B input pulse is in a high state. The MOSFET output transistors 410 and 414 turn off and are discharged through the gate turn-off diodes 402 and 406 when the A or B input pulse is in a low state. A resistor connected to the source of each of the MOSFET output transistors 410 and 414 can be used for current feedback as described above with respect to FIG. 13.

The bridge circuit 58B illustrates the electrical location of the motor 26 and an associated motor coil 418. The motor coil 418 is center-tapped, which allows for a more simplified bridge circuit 58B.

The embodiments of the invention described above illustrate the motor controller 30 as being incorporated in the housing 14 of the hair clipper 10. It should also be noted that the motor controller 30 can be housed in a separate enclosure 422 that can be incorporated within an AC line cord as illustrated in FIG. 15 or the motor controller 30 can be incorporated in a self-contained wall plug 426 as illustrated in FIG. 16.

Various features and advantages of the invention are set forth in the following claims.

What is claimed is:

1. A hair clipper comprising:
a cutting blade;
a pivot motor coupled to the cutting blade; and
a controller operable to controllably provide electric power to the pivot motor to move the cutting blade at a speed greater than 3,600 blade strokes per minute.

2. The hair clipper of claim 1 wherein the controller comprises a power supply and an inverter.

3. The hair clipper of claim 2 wherein the inverter comprises a drive circuit and a bridge circuit, wherein the drive circuit is operable to generate a plurality of pulses that have a variable frequency, the plurality of pulses being operable to control the bridge circuit.

4. The hair clipper of claim 3 wherein the plurality of pulses have a constant width at a frequency.

5. The hair clipper of claim 3 wherein the variable frequency is determined by a user of the hair clipper.

6. The hair clipper of claim 1 wherein the controller comprises a power supply circuit, a drive circuit, and a bridge circuit and wherein the power supply circuit is operable to convert an alternating current (AC) signal to a direct current (DC) signal, the drive circuit is operable to generate a plurality of DC pulses, and the bridge circuit is operable to transform the DC pulses to a variable frequency AC signal that is transmitted to the pivot motor.

7. The hair clipper of claim 1 wherein the pivot motor is constructed as one of a single-ended configuration and a center tapped configuration.

8. The hair clipper of claim 1 wherein the controller is powered by a 120V AC power source.

9. The hair clipper of claim 8 further comprising a housing and an electrical power cord operable to be connected with the 120V AC power source, the electrical power cord comprising an enclosure and the controller is supported by the enclosure.

10. The hair clipper of claim 1 further comprising a housing and wherein the controller is supported by the housing.

11. The hair clipper of claim 1 wherein the controller comprises a “soft start” feature.

12. The hair clipper of claim 1 further comprising a variable speed switch operable by a user, the variable speed switch controlling the resulting speed of the cutting blade.

13. A controller for a pivot motor in a hair clipper, the controller comprising:
a power supply circuit operable to convert an alternating current (AC) signal to a direct current (DC) signal;
a drive circuit operable to receive the DC signal and to generate a plurality of DC pulses; and
a bridge circuit coupled to the pivot motor, the bridge circuit operable to switch the DC pulses, transform the DC pulses to a variable frequency AC signal, and transmit the variable frequency AC signal to the pivot motor.

14. The controller of claim 13 wherein the pivot motor is coupled to a reciprocating blade and operable to move the cutting blade at a speed greater than 3,600 blade strokes per minute.

15. The controller of claim 13 wherein the bridge circuit comprises a plurality of transistors positioned in an H-bridge configuration.

16. The controller of claim 13 wherein the controller is power by a 120V AC power source.

17. A hand-held electrical device comprising:
a housing;
a blade set coupled to the housing, the blade set including a stationary blade and a reciprocating blade;
an actuator supported by the housing, the actuator driveably connected to the blade set; and
a controller supported by the housing, the controller operable to convert an alternating current (AC) signal to a direct current (DC) signal, generate a plurality of DC pulses, and transform the DC pulses to a variable frequency AC signal that is transmitted to the actuator to move the reciprocating blade.

18. The hand-held electrical device of claim 17 wherein the actuator is operable to move the reciprocating blade at a speed greater than 3,600 blade strokes per minute.

19. The hand-held electrical device of claim 17 wherein the actuator comprises a pivot motor constructed in one of a single-ended configuration and a center tapped configuration.

20. The hand-held electrical device of claim 19 wherein the pivot motor is operable to move the reciprocating blade at a speed greater than 3,600 blade strokes per minute.

21. The hand-held electrical device of claim 17 wherein the controller is power by a 120V AC power source.

22. The hand-held electrical device of claim 17 further comprising a variable speed switch operable by a user, the variable speed switch controlling the variable frequency AC signal and a resulting speed of the reciprocating blade.

23. A hair clipper comprising:
a cutting blade;
a vibratory magnetic motor coupled to the cutting blade; and
a controller operable to controllably provide electric power to the pivot motor to move the cutting blade at a speed greater than 7,200 blade strokes per minute.

24. The hair clipper of claim 23 wherein the controller comprises a power supply and an inverter.

25. The hair clipper of claim 24 wherein the inverter comprises a drive circuit and a bridge circuit, wherein the drive circuit is operable to generate a plurality of pulses that have a variable frequency, the plurality of pulses being operable to control the bridge circuit.

26. The hair clipper of claim 25 wherein the plurality of pulses have a constant width at a frequency.

27. The hair clipper of claim 25 wherein the variable frequency is determined by a user of the hair clipper.

28. The hair clipper of claim 23 wherein the controller comprises a power supply circuit, a drive circuit, and a bridge circuit and wherein the power supply circuit is operable to convert an alternating current (AC) signal to a direct current (DC) signal, the drive circuit is operable to generate a plurality of DC pulses, and the bridge circuit is operable to transform the DC pulses to a variable frequency AC signal that is transmitted to the pivot motor.

29. The hair clipper of claim 23 wherein the vibratory magnetic motor is constructed as one of a single-ended configuration and a center tapped configuration.

30. The hair clipper of claim 23 wherein the controller is powered by a 120V AC power source.

31. The hair clipper of claim 30 further comprising a housing and an electrical power cord operable to be connected with the 120V AC power source, the electrical power cord comprising an enclosure and the controller is supported by the enclosure.

32. The hair clipper of claim 23 further comprising a housing and wherein the controller is supported by the housing.

33. The hair clipper of claim 23 wherein the controller comprises a “soft start” feature.

34. The hair clipper of claim 23 further comprising a variable speed switch operable by a user, the variable speed switch controlling the resulting speed of the cutting blade.
